(19) United States
(12) Patent Application Publication
(10) Pub. No.: US 2026/0350167 A1
(43) Pub. Date: Nov. 5, 2026

(54) TRANSFORMER-BASED RANSOMWARE DETECTION FOR MEMORY COMMANDS

(71) Applicant: SAMSUNG ELECTRONICS CO., LTD., SUWON-SI (KR)

(72) Inventors: Amit Berman, Tel Aviv (IL); Elisha Halperin, Tel Aviv (IL); Evgeny Blaichman, Tel Aviv (IL)

(21) Appl. No.: 19/196,188

(22) Filed: May 1, 2025

(51) Int. Cl. G06F 21/56

(52) U.S. Cl. CPC G06F 21/566; G06F 2221/034

(57) ABSTRACT

A method, apparatus, non-transitory computer readable medium, and system for ransomware detection include obtaining a memory command that indicates an operation of a memory device. Ransomware information for the memory command is generated using a transformer model, where the ransomware information indicates a presence of a ransomware attack on the memory device. The memory command is executed based on the ransomware information.

### BACKGROUND

The following relates generally to ransomware detection, and more specifically to detecting ransomware for memory commands. Recent years have seen a significant rise in both the prevalence and the pervasiveness of ransomware attacks with growing focus on the business sector. As businesses migrate their data to memory devices such as Non-Volatile Memory express solid state Drive (NVMe SSD), attacking such devices becomes lucrative, which calls for proper defense mechanisms such as ransomware detection tailored for memory devices. Appropriate features for the ransomware detection schemes include resistance to disabling by the malicious software and timely protection against further ransomware attacks. Solutions with such features include utilizing the incoming memory commands to detect ransomware. Suitable design of such solutions may avoid aggregating the command stream for space efficiency and specificity concerns.

The present disclosure further relates to the field of machine learning, in particular application of transformer models. Transformer is a model architecture that, instead of recurrence, relies on an attention mechanism to draw global dependencies between input and output. Particularly, self-attention is an attention mechanism relating different positions of a single sequence in order to compute a representation of the sequence. Examples of transformer models include vision transformers, Generative Pre-trained Transformers (GPTs), Bidirectional Encoder Representations from Transformers (BERT), A Lite BERT (ALBERT).

### SUMMARY

The present disclosure describes systems and methods for ransomware detection, particularly for ransomware detection based on transformer models for memory commands. Embodiments of the present disclosure include a ransomware detection apparatus that applies a transformer model to generate ransomware information prediction for a memory command stored on memories. In some examples, the memories include non-volatile memories; in one or more examples the non-volatile memories include SSDs. In some examples, the memory command includes a command for memory operation such as read or write; in one or more examples, the memory operation is performed on Non-Volatile Memory such as SSDs, and the memory command may be an NVMe command in a sequence of NVMe commands. In some embodiments, the ransomware detection apparatus is robust against malware disabling attempts and may effectively protect memory devices from against further ransomware attacks by generating accurate, command-specific prediction of existence of ransomware without excessive consumption of computational resource such as memory space.

A method, apparatus, electronic device, non-transitory computer readable medium, and system for ransomware detection are described. One or more aspects of the method, apparatus, non-transitory computer readable medium, and system include obtaining a memory command that indicates an operation of a memory device; generating, using a transformer model, ransomware information for the memory command, wherein the ransomware information indicates a presence of a ransomware attack on the memory device; and executing the memory command based on the ransomware information.

A non-transitory computer readable medium, method, apparatus, electronic device, and system for ransomware detection are described. One or more aspects of the non-transitory computer readable medium, method, apparatus, and system include a non-transitory computer readable medium storing code for ransomware detection, the code including instructions that, when executed by at least one processor, cause the at least one processor to perform operations including: obtaining a memory command that indicates an operation of a memory device; generating, using a transformer model, ransomware information for the memory command, wherein the ransomware information indicates a presence of a ransomware attack on the memory device; and executing the memory command based on the ransomware information.

An apparatus, electronic device, system, and method for ransomware detection are described. One or more aspects of the apparatus, electronic device, system, and method include a memory device, a processing device coupled to the memory device, the processing device configured to perform operations including: obtaining a memory command that indicates an operation of the memory device; generating, using a transformer model, ransomware information for the memory command, wherein the ransomware information indicates a presence of a ransomware attack on the memory device; and executing the memory command based on the ransomware information.

### BRIEF DESCRIPTION OF THE DRAWINGS

FIG. 1 shows an example of a ransomware detection system according to aspects of the present disclosure.

FIG. 2 shows an example of a method for ransomware detection application according to aspects of the present disclosure.

FIG. 3 shows an example of a transformer network according to aspects of the present disclosure.

FIG. 4 shows an example of a transformer block in the transformer network according to aspects of the present disclosure.

FIG. 5 shows an example of a computing device for ransomware detection according to aspects of the present disclosure.

FIG. 6 is a detailed block diagram of a non-volatile memory device, according to aspects of the present disclosure.

FIG. 7 is a block diagram of the memory cell array of FIG. 6, according to aspects of the present disclosure.

FIG. 8 shows an example of a method for ransomware detection according to aspects of the present disclosure.

FIG. 9 shows an example of a system for generating tokens according to aspects of the present disclosure.

FIG. 10 shows an example of a system for token generation based on a sequence of memory commands according to aspects of the present disclosure.

FIG. 11 shows an example of a system for token generation and embedding for a memory command according to aspects of the present disclosure.

FIG. 12 shows an example of a system for token embedding based on a sequence of memory commands according to aspects of the present disclosure

FIG. 13 shows an example of a ransomware information generation system for a sequence of memory commands according to aspects of the present disclosure.

FIG. 14 shows an example of a step-by-step procedure for training a machine learning model according to aspects of the present disclosure.

### DETAILED DESCRIPTION

The present disclosure describes methods, systems and non-transitory computer readable medium for ransomware detection for memory commands. Embodiments of the present disclosure include a ransomware detection apparatus that generates ransomware information for a memory command using a transformer model. In some examples, the ransomware information indicates a presence of a ransomware attack on the memory device. In some cases, the memory commands include commands stored in non-volatile memory devices, such as Non-Volatile Memory express solid state Drive (NVMe SSD). In some cases, the system for ransomware detection is stored on non-volatile memory devices as well. The ransomware detection apparatus improves speed and accuracy for ransomware detection for memory commands and provides efficient defense against ransomware attacks.

NAND programming is a complex process based on applying a voltage to a memory cell. However, cell voltage may be affected by variables such as current voltage level, pulse power, and inter-cell interferences. Cell voltage may also be affected by inhibited cell disruption, inter-word line (WL) coupling, and cell retention. Additionally, the outcome of writing to a NAND device is stochastic. For example, data may also be noisy, leading to problems with observation.

NAND device is a type of flash memory commonly used in SSDs. NVMe provides a commonly used protocol and interface specification for accessing a computer's non-volatile storage such as SSDs. Thus, NAND devices that comply with the NVMe protocol benefits from speed, durability and energy efficiency, potentially providing flexibility for reliable Artificial Intelligence (AI) architecture integration.

Conventional ransomware detection software is typically stored in operating systems. When identifying presence of ransomware in memory commands, such conventional software relies on aggregate statistics of the memory commands, thereby ignoring individuality and sequential nature of the memory commands. Systems, apparatuses and methods in the present disclosure leverage the sequential nature of the memory commands and generate a prediction for each individual command, leading to improved efficiency and accuracy. Additionally, in some embodiments, command-specific features such as file ID or process ID are further explored to improve quality of ransomware detection.

Furthermore, conventional ransomware detection software usually provides level defense that may be circumvented or disabled by the ransomware. In some embodiments of the present disclosure, ransomware detection methods systems are stored in non-volatile memory. For example, ransomware detection system according to aspects of the present disclosure may be based on solid state devices (SSDs). As such, the ransomware detection system of the present disclosure is configured to be resistant against bypass or shut-down attempts of ransomware attacks. This further improves efficiency or validity of ransomware defense.

In some embodiments, without performing data aggregation, the ransomware detection system according to aspects of the present disclosure may further generate a prediction of ransomware presence for an entire sequence of memory commands. In some cases, the prediction indicates a predicted ratio of commands with ransomware attack present among the entire sequence of memory commands. As such, methods and systems in the present disclosure may perform aggregate prediction typically performed by conventional ransomware detection software, with improved accuracy and space or time efficiency.

In some embodiments, upon generating ransomware information for a memory command, the system executes the command based on the ransomware information. In some cases, executing the command includes refraining from executing the command based on prediction that a ransomware attack is present. In some embodiments, upon generating the ransomware information for the memory command, the system triggers an alarm based on the ransomware information. In some embodiments, upon generating the ransomware information for the memory command, the system disables the ransomware attack based on the ransomware information.

In the present disclosure, a “memory command” refers to a computer executable command indicating an operation of a memory device, such as “write certain detain on a certain block of the memory device” or “read certain data from a certain block of the memory device”. In some examples, the memory device is a non-volatile memory device; in one or more examples, the memory device is an NVMe SSD.

In the present disclosure, “ransomware information” refers to information indicating a presence or absence of a ransomware attack in the memory command on the memory device. In some examples, a ransomware attack may include encryption without permission, unauthorized overwriting, reading data from user device via a backdoor, or any combination thereof.

In the present Application, a “transformer model” refers to a type of neural network models used for natural language or machine language processing tasks. A transformer network transforms one sequence into another sequence using an encoder and a decoder. Encoder and decoder include modules that can be stacked on top of each other multiple times. The modules include multi-head attention and feed forward layers. The input tokens are first embedded into an n-dimensional space. Positional encoding of the different tokens is added to the embedded representation (n-dimensional vector) of each token. In some examples, a transformer network includes attention mechanism, where the attention looks at an input sequence and decides at each step to which other parts of the sequence are attended.

### Ransomware Detection

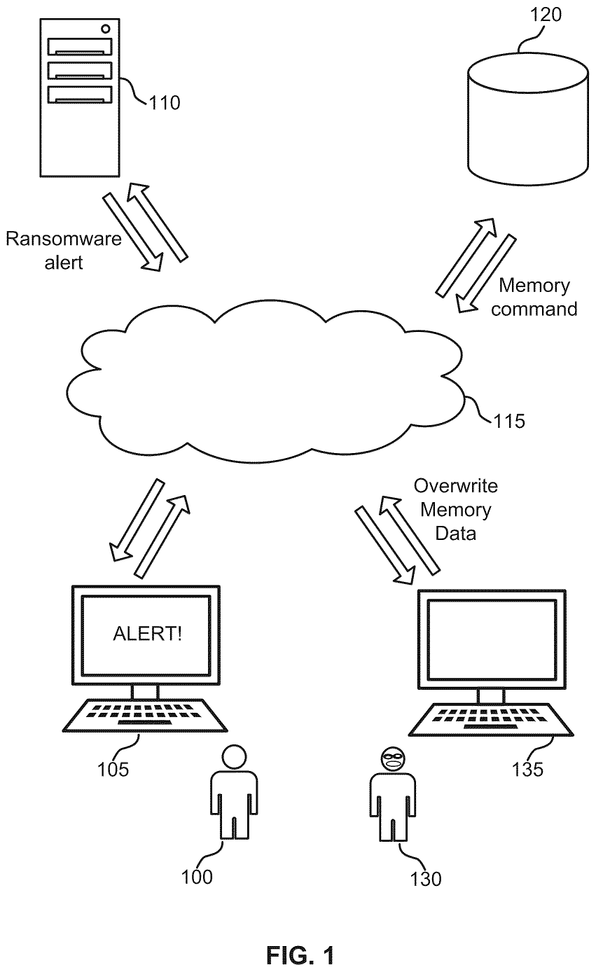

FIG. 1 shows an example of a ransomware detection system according to aspects of the present disclosure. The example shown includes user 100, user device 105, ransomware detection apparatus 110, cloud 115, database 120, attacker 130, and attacker device 135.

Attacker 130 may operate attacker device 135 to issue a ransomware attack to cloud 115. As database 120 transmits a memory command to cloud 115, the memory command may be polluted with the ransomware attack. Ransomware detection apparatus 110, detecting presence of the ransomware attack by interaction with cloud 115, may generate ransomware information indicating the presence and issue a ransomware alert to user device 105 through cloud 115. User device 105 may then display a message informing user 100 of the ransomware alert.

User device 105 may be a personal computer, laptop computer, mainframe computer, palmtop computer, personal assistant, mobile device, or any other suitable computing apparatus. In some examples, user device 105 includes software that incorporates a ransomware detection application. In some examples, the ransomware detection application on user device 105 may include functions of ransomware detection apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser. In some embodiments, the ransomware information refers to information indicating a presence or absence of a ransomware attack in the memory command on the memory device. In some examples, a ransomware attack may include encryption without permission, unauthorized overwriting, reading data from user device via a backdoor, or any combination thereof. In some examples, the user device 105, upon receiving ransomware information indicating presence of a ransomware attack, may trigger an alarm based on the ransomware information, display the alarm, disable the ransomware attack based on the ransomware information, or perform any combination thereof.

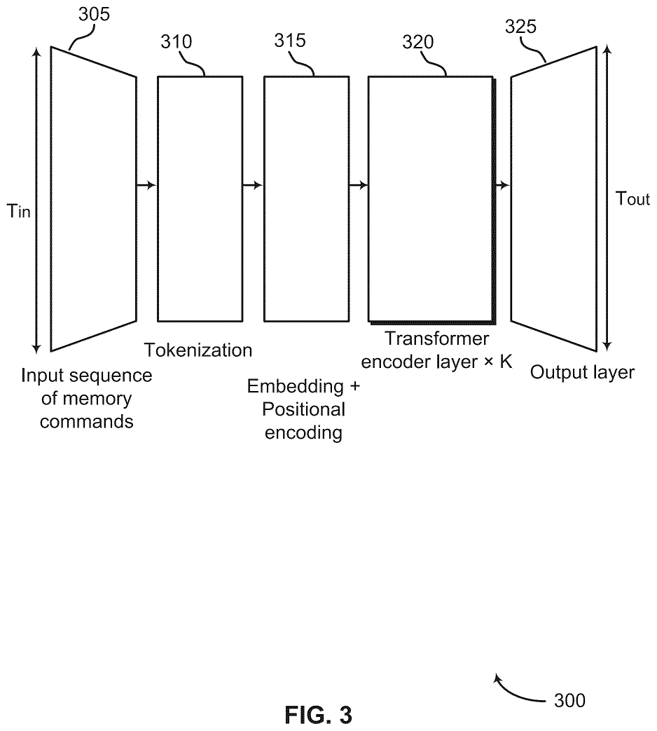

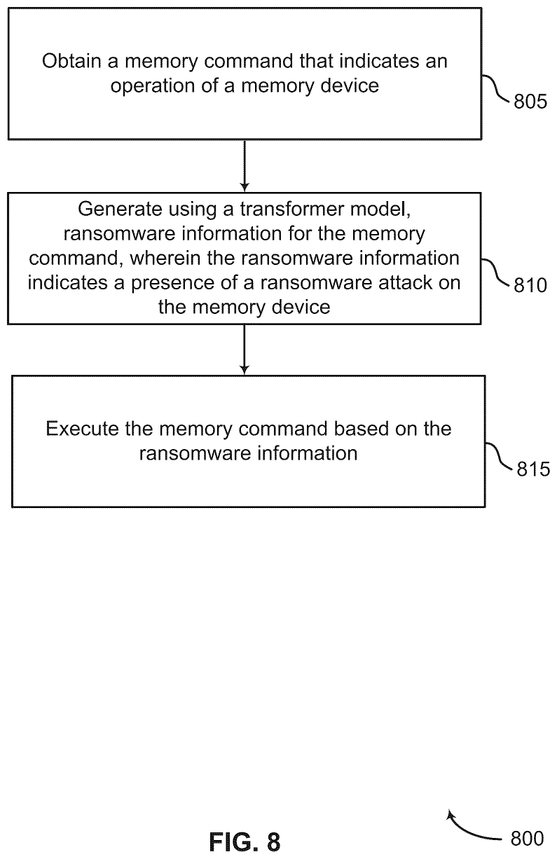

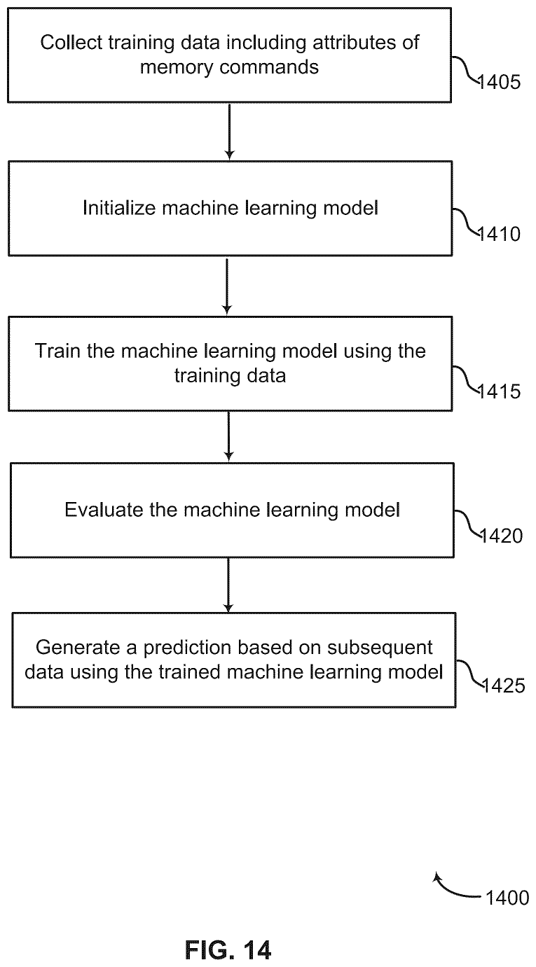

Ransomware detection apparatus 110 includes a computer-implemented network comprising a user interface and training component having stored thereon a machine learning model. Ransomware detection apparatus 110 may also include a processor unit, a memory unit, an I/O module, and a user interface. A training component may be implemented on an apparatus other than ransomware detection apparatus 110. The training component is used to train a machine learning model. Additionally, ransomware detection apparatus 110 can communicate with database 120 via cloud 115. In some cases, the architecture of the machine learning model is also referred to as a network or a network model. In some cases, the ransomware detection apparatus 110 may include a memory device having stored thereon a ransomware detection system or parameters of a machine learning model for ransomware detection according to aspects of the present disclosures. Further detail regarding the architecture of ransomware detection apparatus 110 is provided with reference to FIGS. 3-5. Further detail regarding the operation of ransomware detection apparatus 110 is provided with reference to FIGS. 8 and 14.

In some cases, ransomware detection apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus. In some cases, the ransomware detection apparatus 110 includes a memory device having stored thereon a ransomware detection system or parameters of a machine learning model for ransomware detection according to aspects of the present disclosures.

User device 105 or ransomware detection apparatus 110 includes, or has stored thereon, a transformer model for performing ransomware detection. A transformer model transforms one sequence into another sequence using an encoder and a decoder. Encoder and decoder include modules that can be stacked on top of each other multiple times. The modules include multi-head attention and feed forward layers. The input tokens are first embedded into an n-dimensional space. Positional encoding of the different tokens is added to the embedded representation (n-dimensional vector) of each token. In some examples, a transformer network includes attention mechanism, where the attention looks at an input sequence and decides at each step which other parts of the sequence are important. In some cases, the attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights.

During the training process, attention-weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times. In some examples, the training process is an example of, or includes aspects of, the corresponding element described with reference to FIG. 14.

Cloud 115 is a computer network configured to provide on-demand availability of computer system resources, such as data storage and computing power. In some examples, cloud 115 provides resources without active management by the user. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data (e.g., dataset or parameters for training a machine learning model) in a specified format known as a schema. Database 120 may be structured as a single database, a distributed database, multiple distributed databases, or an emergency backup database. In some cases, a ransomware detection system or parameters of a machine learning model for ransomware detection according to aspects of the present disclosures are stored on the Database 120. In some cases, a database controller may manage data storage and processing in database 120. In some cases, a user interacts with the database controller. In other cases, database controllers may operate automatically without user interaction.

Attacker device 135 may be a personal computer, laptop computer, mainframe computer, palmtop computer, personal assistant, mobile device, or any other suitable processing apparatus. In some examples, attacker device 135 includes software that incorporates a ransomware application which may perform one or more ransomware attacks by issuing such ransomware attacks to the cloud 115 which may further deliver memory commands containing such ransomware attacks to user device 105.

A user interface may enable attacker 130 to interact with attacker device 135. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser. In some cases, attacker 130 interacts with attacker device 135 to perform attacks including encryption without permission, unauthorized overwriting, reading data from user device via a backdoor, or any combination thereof. In some cases, the attacks are carried by one or more memory commands downloaded from cloud 115 to user device 105.

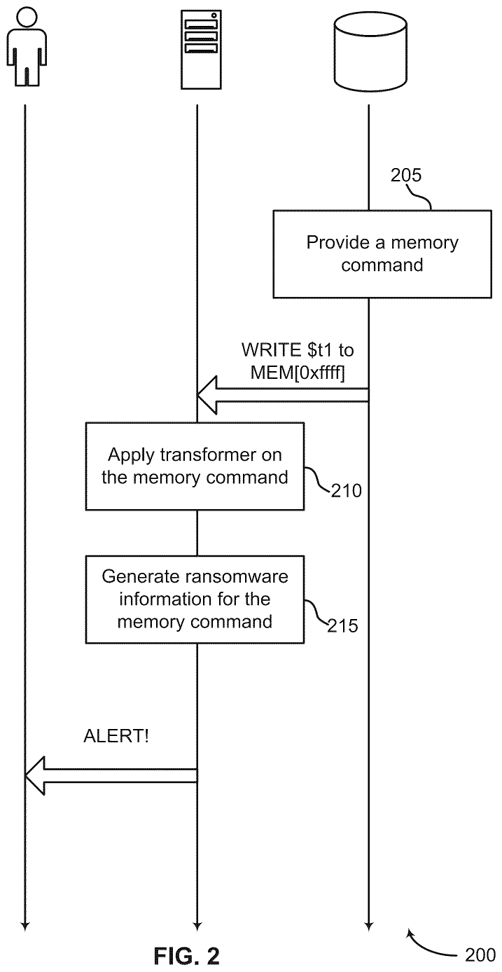

FIG. 2 shows an example of a method 200 for ransomware detection application according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

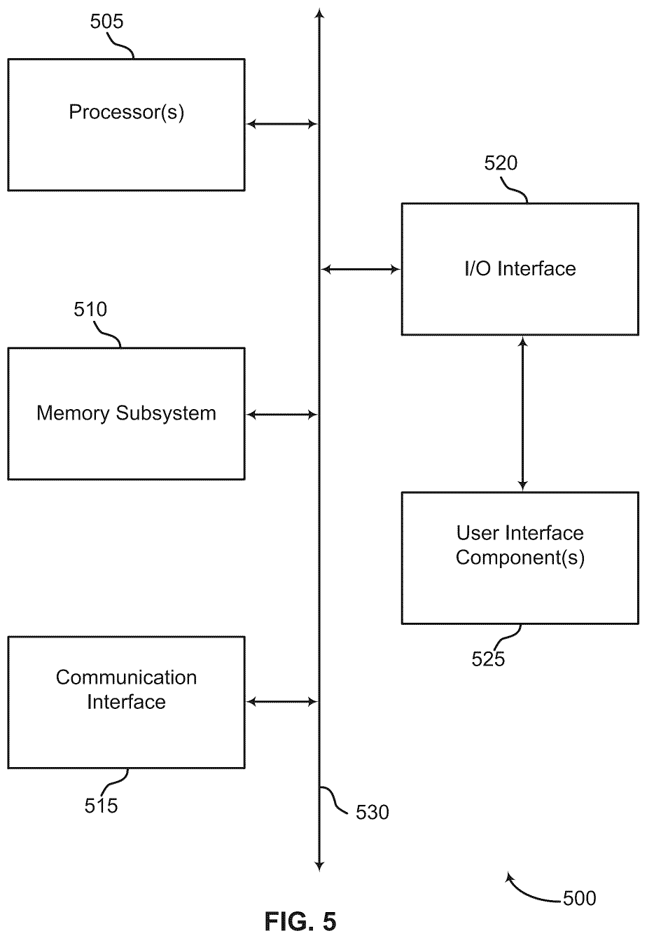

At operation 205, the database provides a memory command to the ransomware detection device. In some embodiments, the memory command refers to a computer executable command indicating an operation of a memory device, such as “write certain detain on a certain block of the memory device” or “read certain data from a certain block of the memory device.” In some cases, the operations of this step refer to, or may be performed by, a database as described with reference to FIG. 1. In some cases, the memory command is stored on a user device as described with reference to FIGS. 1 and 5. In some examples, the memory device is a non-volatile memory device; in one or more examples, the memory device is a Non-Volatile Memory express solid state device (NVMe SSD). In some examples, the memory command is included in a sequence of memory commands.

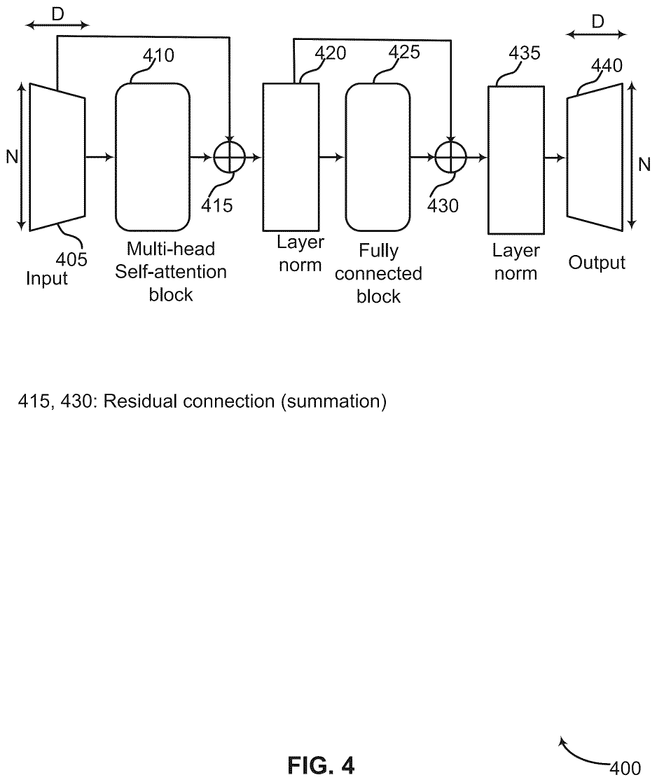

At operation 210, the ransomware detection apparatus applies transformer model on the memory command.” In some embodiments, the transformer model refers to a type of neural network models used for natural language or machine language processing tasks. In some cases, the operations of this step refer to, or may be performed by, a ransomware detection apparatus as described with reference to FIG. 1. In some cases, the transformer model is stored on, or include parameters stored on, a user device as described with reference to FIGS. 1 and 5. In some cases, the transformer model has a network architecture as described with reference to FIGS. 3 and 4. In some cases, the operations of this step refer to, or include aspects of, a method as described with reference to FIG. 8.

At operation 215, the ransomware detection apparatus generates ransomware information for the memory command. In some embodiments, the ransomware information refers to information indicating a presence or absence of a ransomware attack in the memory command on the memory device. In some examples, a ransomware attack may include encryption without permission, unauthorized overwriting, reading data from user device via a backdoor, or any combination thereof. In some examples, the memory command is included in a sequence of memory commands, and the ransomware information further includes a predicted ratio of commands with ransomware attack present among the sequence of memory commands In some cases, the operations of this step refer to, or may be performed by, a ransomware detection apparatus as described with reference to FIG. 1. In some cases, the transformer model is stored on, or include parameters stored on, a user device as described with reference to FIGS. 1 and 5. In some cases, the transformer model has a network architecture as described with reference to FIGS. 3 and 4. In some cases, the operations of this step refer to, or include aspects of, a method as described with reference to FIG. 8. In some cases, the ransomware detection apparatus triggers an alarm based on the ransomware information; in some cases, the ransomware detection displays an alert message to the user based on the triggered alarm.

### Network Architecture

FIG. 3 shows an example of a transformer network according to aspects of the present disclosure. The example shown includes transformer model 300, input layer 305, tokenization layer 310, embedding and positional encoding layer 315, a plurality of transformer encoder layers 320, and output layer 325.

At the input layer 305, the transformer model 300 receives a sequence of memory commands, and passes each of the sequence of memory commands to the tokenization layer 310. In some embodiments, the sequence of memory commands includes a memory command provided as described in reference to FIG. 2. In some cases, the sequence of memory commands are stored in a user device or memory device as described with reference to FIG. 1 or 5.

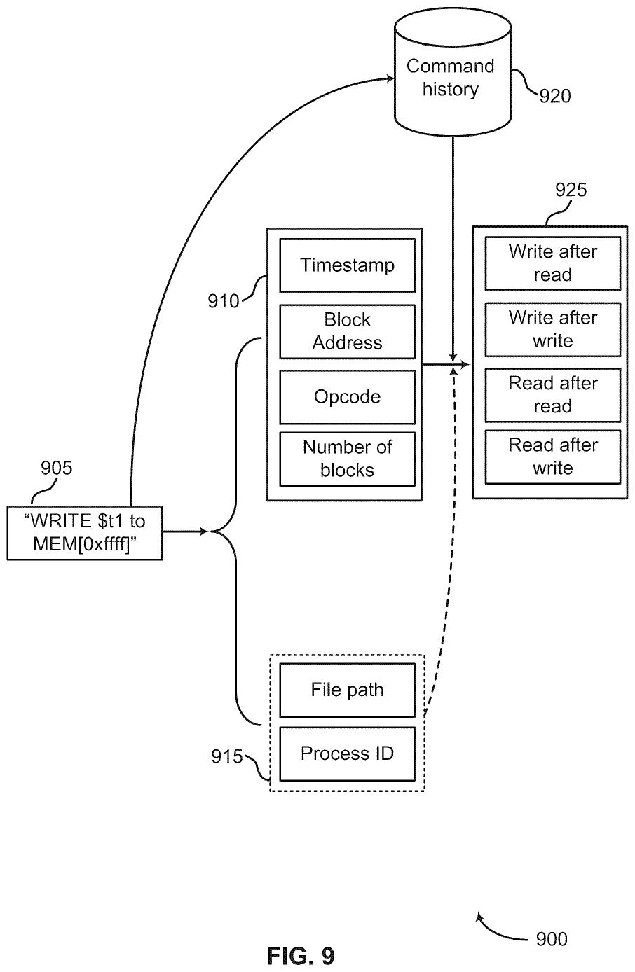

At the tokenization layer 310, the transformer model 300 parses each of the sequence of memory commands into one or more tokens representing features of the memory command. In some cases, ransomware information as described with reference to FIGS. 1-2 is generated based on the one or more tokens. In some cases, the one or more tokens are examples of, or include aspects of, the tokens as described with reference to FIG. 9. In some cases, the one or more tokens include a timestamp, a block address, a number of blocks, an opcode, or any combination of them; in one or more examples, the block address is a logical block address; in one or more examples, the number of blocks account for blocks on which the memory command operates; in one or more examples, the opcode describes or indicates whether the memory command is a read or write operation. In one or more examples, the logical block address is further split into a major half and a minor half, and the one or more tokens further include the major half of the logical block address and the minor half of the logical block address.

In some cases, the one or more tokens further include a file path, a process ID, or both; in some examples, the file path indicates a path to a file on which the memory command operates; in some examples, the process ID identifies a process that initiates the memory command.

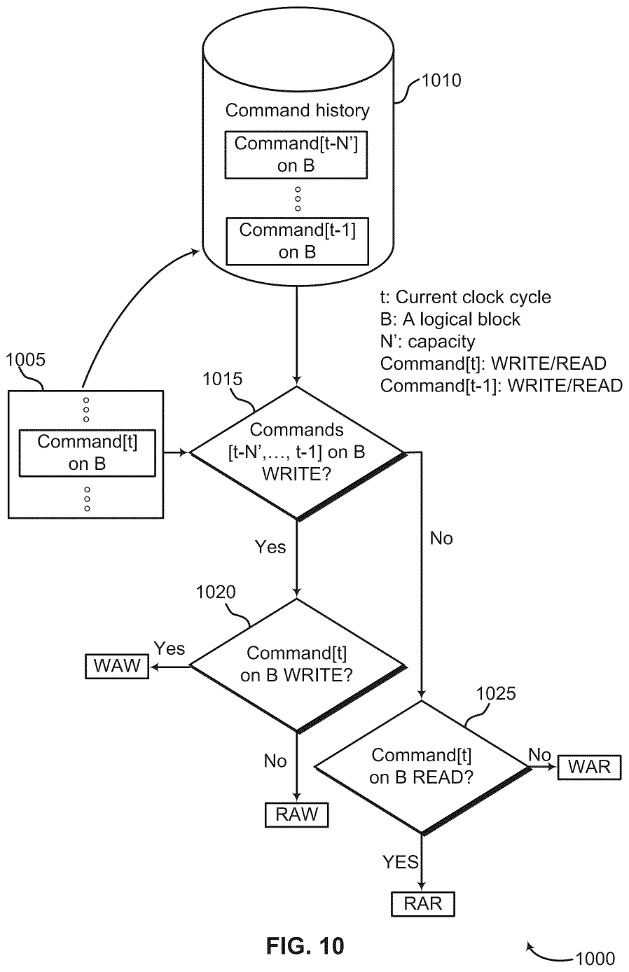

In some cases, the one or more tokens further include tokens generated based on a command attribute including a Write after read (WAR) attribute, a Write after write (WAW) attribute, a Read after read (RAR) attribute, a Read after write (RAW) attribute, or any combination of them. In some cases, if the memory command is a write operation on a block, and a previous read command acts in whole or in part on the same block, the command attribute for the memory command is a WAR; if the memory command is a read operation on a block, and a previous write command acts in whole or in part on the same block, the command attribute for the memory command is a RAW; the definitions for WAW and RAR are analogous. In some cases, ransomware information as described with reference to FIGS. 1-2 is generated based on the command attribute. In some cases, the command attribute is generated based on comparing the memory command with a record in a historical database of recent commands in the sequence of memory commands; in some examples, generation of the command attribute is an example of or includes aspects of a system as described with reference to FIG. 10, and the historical database is an example of or includes aspects of the command history database as described with reference to FIG. 10.

At the embedding and positional encoding layer 315, the transformer model 300 vectorizes the parsed tokens to obtain input embedding, and adds input positional encoding (e.g., positional encoding vectors for input of a same dimension as input embedding) to input embedding. In some cases, input positional encoding includes information about relative positions of tokens in input sequence of memory commands. In some cases, the vectorization of the parse tokens, or the input embedding, is implemented using a linear transformation from a vector space of a first dimension S of the one or more tokens to a vector space of a second dimension, namely embedding dimension D. The input embedding is then passed to the plurality of transformer encoder layers 320. In some cases, the input embedding includes aspects of the training process as described with reference to FIG. 14.

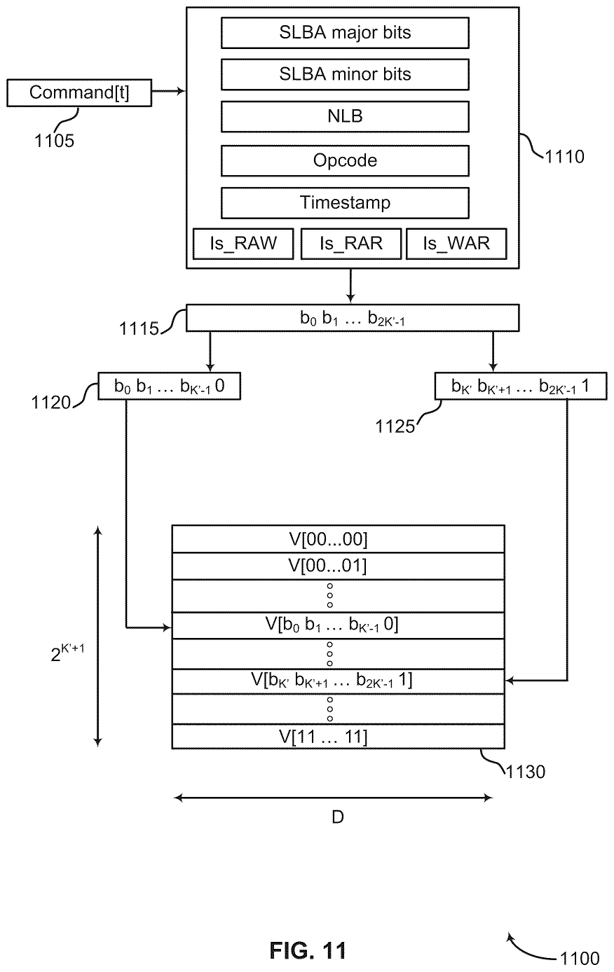

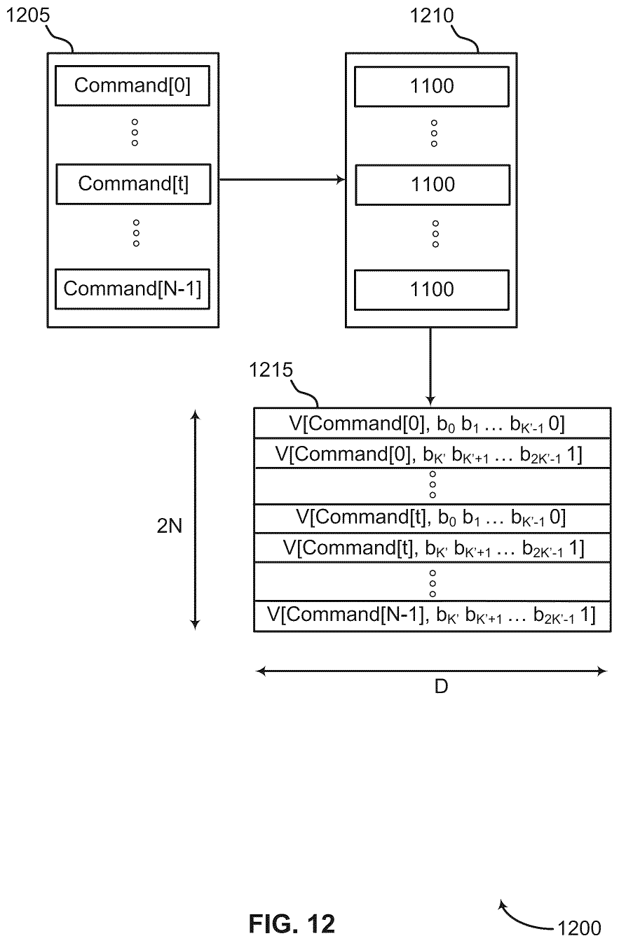

In some embodiments, at the embedding and positional encoding layer 315, to perform positional encoding the transformer model 300 operates on a sliding window or context window of a plurality of continuous commands in the sequence of memory commands. In some examples, the sliding window advances one or more positions in each step, where a number of advanced positions is a stride, and a number N of the plurality of continuous commands included in the sliding window is a size of the sliding window. The stride controls an overlap between tokens of two or more consecutive context windows. Both the size and the stride may be configured. In one or more examples, the size N is 1000 and the stride is 500. In some cases, memory commands contained in a sliding window are examples of, or include aspects of, the command history database as described with reference to FIG. 10. In some cases, a rotary positional encoder is used to perform the positional encoding in the embedding and positional encoding layer 315. In some cases, operations at the tokenization layer 310 and embedding and positional encoding layer 315 are alternatively or additionally performed by, alternatively or additionally include aspects of, systems 1100 and 1200 as described with reference to FIGS. 11-12. In some cases, operations at the tokenization layer 310 and embedding and positional encoding layer 315 are performed by or include aspects of procedure 1400 for training as described with reference to FIG. 14.

Vectors representing tokens and vectors representing positional embeddings are then passed to the plurality of transformer encoder layers 320, where attention-based learning is performed. In some cases, each of the plurality of transformer encoder layers is an example of, or includes aspects of, the transformer block as described with reference to FIG. 4. In one or more examples, a number of layers in the plurality of transformer encoder layers, namely a number of the transformer blocks 400 as described with reference to FIG. 4 that are stacked in the plurality of transformer encoder layers 320, equals 3. In some cases, operations at the plurality of transformer encoder layers 320 are performed by or include aspects of procedure 1400 for training as described with reference to FIG. 14.

The output layer 325 comprises a fully-connected layer of a dimension equal to an input dimension. In some embodiments, a dimension of an output with respect to the sequence of memory commands is either equal to the input dimension or equal to 1.

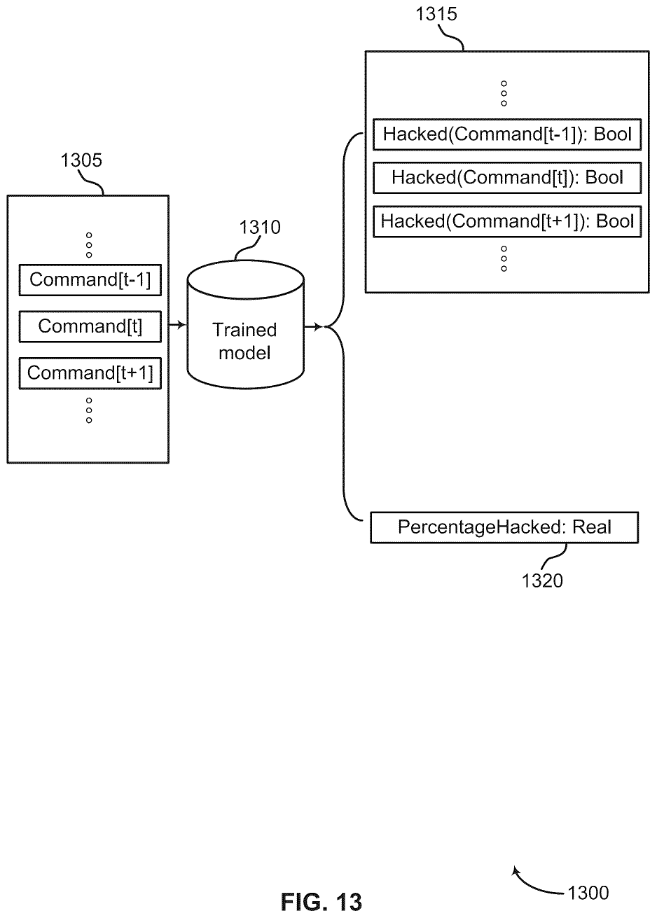

In some cases, the dimension of the output with respect to the sequence of memory commands is equal to the input dimension, where the transformer model 300 detects presence or absence of a ransomware attack for each of the memory command in the sequence of memory commands represented by a Boolean value in a corresponding entry of the output. In some cases, the ransomware detection device described with reference to FIG. 1 executes each of the memory command based on the output or ransomware information; in one or more examples, executing the memory command based on the output includes refraining from executing the memory command. In one or more examples, based on the output or ransomware information, the ransomware detection device described with reference to FIG. 1 further raises alarm over the presence of ransomware, counts the ransomware content in the input, disables the ransomware attacks, or performs any combination thereof. In some cases, the ransomware information at the output layer 325 are an example of, or includes aspects of, ransomware information as described with reference to FIG. 13.

In some cases, the dimension of the output with respect to the sequence of memory commands is equal to 1, where the transformer model 300 detects presence of one or more ransomware attacks in the sequence of memory commands. In some cases, the output or ransomware information is a real number between 0 and 1, both ends inclusive, representing a fraction of commands with ransomware attacks present among the sequence of commands. In some cases, the ransomware detection device described with reference to FIG. 1 executes the sequence of the memory commands based on the output or ransomware information; in one or more examples, executing the sequence of memory commands based on the output includes refraining from executing an entirety or part of the sequence of memory commands. In one or more examples, based on the output or ransomware information, the ransomware detection device described with reference to FIG. 1 further raises alarm over the presence of ransomware, measures the ransomware content in the input, disables the ransomware attacks, or performs any combination thereof. In some cases, the ransomware information at the output layer 325 are an example of, or includes aspects of, ransomware information as described with reference to FIG. 13. In some cases, operations at the output layer are performed by or include aspects of procedure 1400 for training as described with reference to FIG. 14.

FIG. 4 a transformer block 400 in the transformer network according to aspects of the present disclosure. The example shown includes transformer input block 405, multi-head self-attention block 410, first residual connection 415, first layer norm 420, fully connected block 425, second residual connection 430, second layer norm 435, and transformer output block 440.

At the transformer input block 405, the transformer block 400 receives a layer input of dimension N×D, where N is a number of memory commands in the sequence of memory commands as described with reference to FIGS. 1-3, and D is an embedding dimension of the token embedding as described with reference to FIG. 3. In one or more examples, N=1000; in one or more examples, D=256.

At the multi-head self-attention block 410, a multi-head self-attention mechanism that receives different linearly projected versions of queries, keys, and values to produce outputs in parallel is implemented. In some cases, the self-attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights. In one or more examples, the multi-head self-attention block 410 implements multiple single-attention functions in parallel by introducing a mask over values produced by the scaled multiplication of matrices Q and K by suppressing matrix values that would otherwise correspond to disallowed connections. In some examples, a number H of attention heads is 4.

At the first residual connection 415, a sum x+sublayer(x) is computed, where x is an input from transformer input block 405, and sublayer(x) is an output from the multi-head self-attention block 410 corresponding to x. At the first layer norm 420, the sum x+sublayer(x) from the first residual connection 415 is normalized by a layernorm function. In some cases, the layer norm function includes renormalizing by recentering a distribution and adjusting a standard deviation. In some cases, the output of the first layer norm 420 has width D, with D is an embedding dimension of the token embedding as described with reference to FIG. 3 and transformer input block 405. A result of the first layer norm 420 is then passed to the fully connected block 425.

At the fully connected block 425, an input dimension and an output dimension are both D, with D is an embedding dimension of the token embedding as described with reference to FIG. 3 and transformer input block 405. In some cases, the fully connected block 425 computes two linear transformations surrounding a Rectified Linear Unit (ReLU) activation:

$$F F N ( x ) = R e L U ( {W}_{1} x + {b}_{1} ) {W}_{2} + {b}_{2} \qquad ( 1 )$$

where x is the input to the fully connected block 425 namely the result from the first layer norm 420, W₁, W₂ are learnable weight parameters, b₁, b₂ are bias terms, and ReLU(*)=max(*,0) is a nonlinearity function.

At the second residual connection 430, a sum x+FFN(x) is computed, where x is the result from the first layer norm 420, and FFN(x) is an output from the fully connected block 425 corresponding to x (See Equation (1)). At the second layer norm 435, the sum x+FFN(x) from the second residual connection 430 is normalized by a layernorm function. In some cases, the layer norm function includes renormalizing by recentering a distribution and adjusting a standard deviation. In some cases, the output of the second layer norm 435 has width D, with D is an embedding dimension of the token embedding as described with reference to FIG. 3 and transformer input block 405. A result of the second layer norm 435 is then passed to the transformer output block 440.

At the transformer output block 440, the transformer block 400 transmits a layer output of dimension N×D, where N is a number of memory commands in the sequence of memory commands as described with reference to FIGS. 1-3 and transformer input block 405, and D is an embedding dimension of the token embedding as described with reference to FIG. 3 and transformer input block 405. Iat one or more examples, N=1000; in one or more examples, D=256.

FIG. 5 shows an example of a computing device 500 for document processing according to aspects of the present disclosure. The computing device 500 may be an example of the ransomware detection apparatus 110 described with reference to FIG. 1. In one aspect, computing device 500 includes one or more processors 505, memory subsystem 510, communication interface 515, I/O interface 520, user interface component(s) 525, and channel 530.

In some embodiments, computing device 500 is an example of, or includes aspects of, the ransomware detection apparatus of FIG. 1. In some embodiments, computing device 500 includes one or more processors 505 that can execute instructions stored in memory subsystem 510 to perform media generation.

According to some aspects, computing device 500 includes one or more processors 505. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

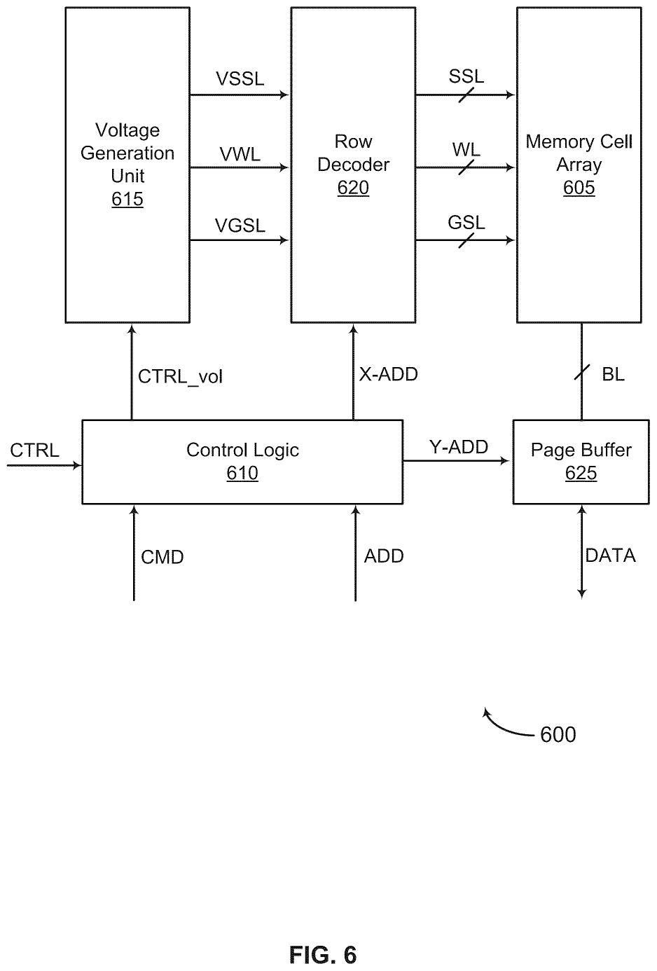

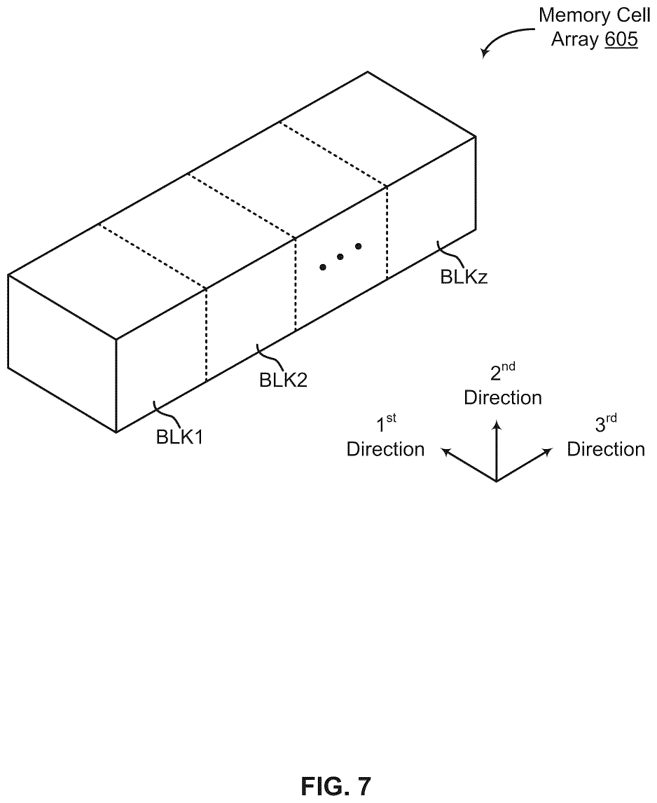

According to some aspects, memory subsystem 510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state. In some cases, the memory subsystem includes Non-volatile memory devices, such as an NVMe SSD. In some examples, the Non-volatile memory devices are examples of, or include aspects of, non-volatile memory device as described with reference to FIGS. 6-7. In some cases, the memory subsystem has stored thereon, or has stored thereon parameters of, the transformer model as described with reference to FIGS. 1-4.

According to some aspects, communication interface 515 operates at a boundary between communicating entities (such as computing device 500, one or more user devices, a cloud, and one or more databases) and channel 530 and can record and process communications. In some cases, communication interface 515 is provided to enable a processing system coupled to a transceiver (e.g., a transmitter and/or a receiver). In some examples, the transceiver is configured to transmit (or send) and receive signals for a communications device via an antenna. In some cases, the communication interface 515 interacts with the cloud as described with reference to FIG. 1.

According to some aspects, I/O interface 520 is controlled by an I/O controller to manage input and output signals for computing device 500. In some cases, I/O interface 520 manages peripherals not integrated into computing device 500. In some cases, I/O interface 520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 520 or via hardware components controlled by the I/O controller.

According to some aspects, user interface component(s) 525 enable a user to interact with computing device 500. In some cases, user interface component(s) 525 include an audio device, such as an external speaker system, an external display device such as a display screen, an input device (e.g., a remote-control device interfaced with a user interface directly or through the I/O controller), or a combination thereof. In some cases, user interface component(s) 525 include a GUI.

FIG. 6 is a detailed block diagram of a non-volatile memory device 600, according to aspects of the present disclosure. Referring to FIG. 6, the non-volatile memory device 600 may include, for example, a memory cell array 605, a control logic 610, a voltage generation unit 615, a row decoder 620, and a page buffer 625. In some cases, the non-volatile memory device 600 is an example of, or include aspects of, the memory device as described with FIGS. 1-2 or the one or more memory devices as described with reference to FIG. 5.

The memory cell array 605 may be connected to one or more string select lines SSL, a plurality of word lines WL, one or more ground select lines GSL, and a plurality of bit lines BL. The memory cell array 605 may include a plurality of memory cells disposed at intersections between the plurality of word lines WL and the plurality of bit lines BL.

The control logic 610 may receive a command CMD (e.g., an internal command) and an address ADD from a memory controller and receive a control signal CTRL for controlling various functional blocks within the non-volatile memory device 600 from the memory controller. The control logic 610 may output various control signals for writing data to the memory cell array 605 or reading data from the memory cell array 605, based on the command CMD, the address ADD, and the control signal CTRL. In this manner, the control logic 610 may control the overall operation of the non-volatile memory device 600.

The various control signals output by the control logic 610 may be provided to the voltage generation unit 615, the row decoder 620, and the page buffer 625. For example, the control logic 610 may provide the voltage generation unit 615 with a voltage control signal CTRL_vol, provide the row decoder 620 with a row address X-ADD, and provide the page buffer 625 with a column address Y-ADD.

The voltage generation unit 615 may generate various voltages for performing program, read, and erase operations on the memory cell array 605 based on the voltage control signal CTRL_vol. For example, the voltage generation unit 615 may generate a first driving voltage VWL for driving the plurality of word lines WL, a second driving voltage VSSL for driving the plurality of string select lines SSL, and a third driving voltage VGSL for driving the plurality of ground select lines GSL. In this case, the first driving voltage VWL may be a program voltage (e.g., a write voltage), a read voltage, an erase voltage, a pass voltage, or a program verify voltage. In addition, the second driving voltage VSSL may be a string select voltage (e.g., an on voltage or an off voltage). Further, the third driving voltage VGSL may be a ground select voltage (e.g., an on voltage or an off voltage).

The row decoder 620 may be connected to the memory cell array 605 through the plurality of word lines WL and may activate a part of the plurality of word lines WL in response to the row address X-ADD received from the control logic 610. For example, in a read operation, the row decoder 620 may apply a read voltage to a selected word line and a pass voltage to unselected word lines.

In a program operation, the row decoder 620 may apply a program voltage to a selected word line and a pass voltage to unselected word lines. In an embodiment, in at least one of a plurality of program loops, the row decoder 620 may apply the program voltage to the selected word line and an additionally selected word line.

The page buffer 625 may be connected to the memory cell array 605 through the plurality of bit lines BL. For example, in a read operation, the page buffer 625 may operate as a sense amplifier that outputs data stored in the memory cell array 605. Alternatively, in a program operation, the page buffer 625 may operate as a write driver that writes desired data to the memory cell array 605.

FIG. 7 is a block diagram of the memory cell array 605 of FIG. 6, according to aspects of the present disclosure. Particularly, FIG. 7 illustrate an example in which the non-volatile memory device 600 is implemented using a three-dimensional flash memory. The three-dimensional flash memory may include three-dimensional (e.g., vertical) NAND (e.g., VNAND) memory cells.

Referring to FIG. 7, the memory cell array 605, according to an embodiment, includes a plurality of memory blocks BLK1 to BLKz. Each of the memory blocks BLK1 to BLKz has a three-dimensional structure (e.g., a vertical structure). For example, each of the memory blocks BLK1 to BLKz may include structures extending in first to third directions. For example, each of the memory blocks BLK1 to BLKz may include a plurality of NAND strings extending in the second direction. The plurality of NAND strings may be provided, for example, in the first to third directions.

Each of the NAND strings is connected to a bit line BL, a string select line SSL, a ground select line GSL, word lines WL, and a common source line CSL. That is, each of the memory blocks BLK1 to BLKz may be connected to a plurality of bit lines BL, a plurality of string select lines SSL, a plurality of ground select lines GSL, a plurality of word lines WL, and a common source line CSL.

### Inference or Algorithm

FIG. 8 shows an example of a method 800 for ransomware detection according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 805, the system obtains a memory command that indicates an operation of a memory device. In some cases, the memory command is an example of, or includes aspects of, the memory command as described with refence to FIGS. 1-2. In some cases, the memory device is an example of, or includes aspects of, the memory device as described with refence to FIGS. 1-2. In some examples, at operation 805, the system obtains a sequence of memory commands, where the ransomware information is based on the sequence of memory commands. In some cases, the operations of this step refer to, or may be performed by, user interface component(s) as described with reference to FIG. 5 or user device as described with reference to FIG. 1.

At operation 810, the system generates ransomware information for the memory command, where the ransomware information indicates a presence of a ransomware attack on the memory device. In some cases, the ransomware information is an example of, or includes aspects of, the ransomware information as described with refence to FIGS. 1-2. In some cases, the ransomware attack is an example of, or includes aspects of, the ransomware attack as described with refence to FIGS. 1-2. In some examples, at operation 810, the system obtains a position encoding for the memory command; and performs a self-attention operation of the memory command based on the position encoding. In some cases, the operations of this step refer to, or may be performed by, the one or more processors 505 as described with reference to FIG. 5, or transformer models as described with reference to FIGS. 3-4.

At operation 815, the system executes the memory command based on the ransomware information. In some cases, executing the memory command may include refraining from execution of the memory command upon determination that the ransomware attack is present in the memory command. In some cases, the operations of this step refer to, or may be performed by, the one or more processors as described with reference to FIG. 5, user device with reference to FIG. 1, or transformer models as described with reference to FIGS. 3-4.

In FIGS. 1-8, a method, apparatus, electronic device, non-transitory computer readable medium, and system for ransomware detection are described. One or more aspects of the method, apparatus, electronic device, non-transitory computer readable medium, and system include obtaining a memory command that indicates an operation of a memory device; generating, using a transformer model, ransomware information for the memory command, wherein the ransomware information indicates a presence of a ransomware attack on the memory device; and executing the memory command based on the ransomware information.

In some cases, the method, apparatus, electronic device, non-transitory computer readable medium, and system includes obtaining a sequence of memory commands including the memory command, where each of the sequence of memory commands indicates an operation of the memory device; generating, using the transformer model, ransomware information corresponding to each of the sequence of memory commands, where the corresponding ransomware information indicates a presence of the ransomware attack on the memory device; and executing each of the sequence of memory commands based on the corresponding ransomware information.

Some examples of the method, apparatus, electronic device, non-transitory computer readable medium, and system further include generating one or more tokens representing features of the memory command, where the ransomware information is generated based on the one or more tokens. In some examples of the method, apparatus, electronic device, non-transitory computer readable medium, and system, the one or more tokens include a timestamp, a block address, a number of blocks, an opcode, or any combination thereof. In some examples of the method, apparatus, electronic device, non-transitory computer readable medium, and system, the one or more tokens comprise a file path, a Process ID (PID), or both.

Some examples of the method, apparatus, electronic device, non-transitory computer readable medium, and system further include obtaining a command attribute including a Write after read (WAR) attribute, a Write after write (WAW) attribute, a Read after read (RAR) attribute, a Read after write (RAW) attribute, or any combination thereof, where the ransomware information is generated based on the command attribute.

Some examples of the method, apparatus, electronic device, non-transitory computer readable medium, and system further include triggering an alarm based on the ransomware information. Some examples of the method, apparatus, electronic device, non-transitory computer readable medium, and system further include disabling the ransomware attack based on the ransomware information.

In some examples of the method, apparatus, electronic device, non-transitory computer readable medium, and system, obtaining the memory command includes obtaining a sequence of memory commands, wherein the ransomware information includes a command-specific ransomware indicator for each of the sequence of memory commands, respectively. In some examples of the method, apparatus, electronic device, non-transitory computer readable medium, and system, generating the ransomware information includes obtaining a position encoding for the memory command, and performing a self-attention operation of the memory command based on the position encoding. In some examples of the method, apparatus, electronic device, non-transitory computer readable medium, and system, the transformer model is trained using training data including a sequence of memory commands.

In some examples of the method, apparatus, electronic device, non-transitory computer readable medium, and system, the memory device includes a non-volatile memory. In some examples of the method, apparatus, electronic device, non-transitory computer readable medium, and system, the memory device includes a solid state device.

FIG. 9 shows an example of a system 900 for generating tokens according to aspects of the present disclosure. The example shown includes system 900, memory command 905, a first group of tokens 910, a second group of tokens 915, a command history database 920, and a third group of tokens 925.

The system 900 parses or generates the memory command 905 into the first group of tokens 910, the second group of tokens 915, and the third group of tokens 925, where the third group of tokens 925 are generated based on comparison with records in the command history database 920. The memory command 905 is included in a sequence of memory commands. In some cases, the memory command 905 is an example of, or includes aspects of, the memory command as described with reference to FIGS. 1-2 and 10. In some cases, the sequence of memory command is an example, or includes aspects of, the sequence of memory commands as described with reference to FIGS. 1, 3 and 10. In some cases, the memory command is stored in the command history database 920.

The first group of tokens 910 is mandatorily included in the tokenization step as described with reference to FIG. 3. In some cases, the first group of tokens 910 include a timestamp, a block address, a number of blocks, an opcode, or any combination of them; in one or more examples, the block address is a logical block address; in one or more examples, the number of blocks account for blocks on which the memory command operates; in one or more examples, the opcode describes or indicates whether the memory command is a read or write operation. In one or more examples, the logical block address is further split into a major half and a minor half, and the one or more tokens further include the major half of the logical block address and the minor half of the logical block address. In some cases, the first group of tokens 910 is an example of, or includes aspects of, the one or more tokens as described with reference to FIG. 3.

The second group of tokens 915 is included alternatively or additionally in the tokenization step as described with reference to FIG. 3. Dotted line around the second group of tokens 915 denotes that File path and Process ID is included alternatively or additionally. In some cases, the second group of tokens 915 includes a file path, a process ID, or both; in some examples, the file path indicates a path to a file on which the memory command operates; in some examples, the file path is represented by a file identifier (FID). In some examples, the process ID identifies a process that initiates or issues the memory command. In some cases, the second group of tokens 915 is an example of, or includes aspects of, the one or more tokens as described with reference to FIG. 3.

The command history database 920 stores memory commands in a sequence of memory commands that occurred up to the memory command 905. In some cases, the memory commands stored in the command history database 920 are contained in the sliding window as described with reference to FIG. 3. In some cases, the command history database 920 is an example of, or includes aspects of, the database as described with reference to FIGS. 1-2 and 10.

The third group of tokens 925 is generated based on the first group of tokens 910, and additionally or alternatively, the second group of tokens 915, and by comparison with records in the command history database 920. In some cases, the third group of tokens 925 includes tokens generated based on a command attribute including a Write after read (WAR) attribute, a Write after write (WAW) attribute, a Read after read (RAR) attribute, a Read after write (RAW) attribute, or any combination of them. In some cases, the third group of tokens 925 is an example of, or includes aspects of, the one or more tokens as described with reference to FIG. 3. In some cases, generation of the third group of tokens by comparison with records in the command history database 920 refers to, or may be performed by, the generation process as described with reference to FIGS. 3 and 10.

FIG. 10 shows an example of a system 1000 for token generation based on a sequence of memory commands according to aspects of the present disclosure. The example shown includes system 1000, memory command 1005, a command history database 1010, a first decision block 1015, a second decision block 1020, and a third decision block 1025.

The memory command 1005 is a current command at a current clock cycle t operating on a memory block B, also denoted as Command[t] on B. The memory command 1005 is included in a sequence of memory commands. In some cases, the memory block is a logical block. In some cases, the memory command 1005 is an example of, or includes aspects of, the memory command as described with reference to FIGS. 1-2 and 9. In some cases, the sequence of memory command is an example, or includes aspects of, the sequence of memory commands as described with reference to FIGS. 1, 3-4 and 9. In some cases, the transformer model processes one command in the sequence of memory commands per clock cycle. In some cases, the memory command is stored in the command history database 1010.

The command history database 1010 stores memory commands in a sequence of memory commands that occurred up to the memory command 1005. In some cases, the memory commands stored in the command history database 920 are contained in the sliding window as described with reference to FIG. 3. In some cases, the command history database 1010 is an example of, or includes aspects of, the database as described with reference to FIGS. 1-2 and 9.

If the command history database 1010 contains a memory command occurring in the sequence of memory commands before Command[t] on B that operates in part or in whole on B, the system makes a decision at the first decision block 1015. The first decision block 1015 determines if memory commands occurring in the sequence before Command[t] on B that operates in part or in whole on B, hereinafter abbreviated as Commands[(t−N′), . . . , (t−1)] on B, are write commands: if yes, the system makes a decision at the second decision block 1020; otherwise, the system makes a decision at the third decision block 1025. N′ represents a capacity or an amount of memory commands in the sequence that have been saved in the command history database 1010. In the present disclosure, N′ is not necessarily related to N.

The second decision block 1020 determines if the Command[t] on B is a write command on B. If yes, a command attribute corresponding to the memory command 1005 or Command[t] on B is a WAW; otherwise, the command attribute corresponding to Command[t] on B is a RAW. The third decision block 1025 determines if the Command[t] on B is a read command on B. If yes, the command attribute corresponding to the memory command 1005 or Command[t] on B is a RAR; otherwise, the command attribute corresponding to Command[t] on B is a WAR. For simplicity of narration, it is assumed that in this example, memory commands Command[t] on B and Commands[(t−N′), . . . , (t−1)] on B are read or write commands on B; in some cases, memory commands are not limited to read or write on B. In some cases, the system further generates tokens corresponding to the command attribute. In some cases, the first decision block 1015, the second decision block 1020 and the third decision block 1025 are examples of, or are implemented by, the command attribute generation as described with reference to FIG. 3.

FIG. 11 shows an example of a system for token generation and embedding for a memory command according to aspects of the present disclosure. The example shown includes system 1100, a memory command 1105, a collection of tokens 1110, a token string 1115, first token 1120, second token 1125, and a maintained matrix 1130.

In some embodiments, the memory command 1105 is parsed into the collection of tokens 1110 including Starting Logical Block Address (SLBA) major bits, SLBA minor bits, Number of Logical Blocks (NLB), Opcode, Timestamp, and 3 bits indicating whether the memory commend 1105 is WAR, RAR, or RAW, respectively denoted as IS_WAR, IS_RAR, or IS_RAW. In some cases, NLB is computed by rounding down log(NLB) and taking minor bits of the result; in some cases, Opcode is 1 bit; in some cases, Timestamp is computed by first computing dt, a difference between the memory command 1105 and its previous command, then rounding down log(dt×10⁶), and taking minor bits of the result. In some cases, the collection of tokens includes aspects of components as described with reference to FIG. 9.

In some embodiments, the collection of tokens 1110 is transformed into a token string 1115. In some cases, the token string includes 2K′ number of bits, where K′ is a positive integer. In the present disclosure, K′ is not necessarily related to K. In FIG. 11, the token string 1115 is represented as b₀b₁ . . . b_{2K′-1}. The token string 1115 is split into a first half b₀b₁ . . . b_{K′-1} and a second half b_{K},b_{K′+1} . . . b_{2K′-1}. The system 1100 attaches a bit 0 to the first half to produce first token 1120 (b₀b₁ . . . b_{K′-1}0) and attaches a bit 1 to the second half to produce second token 1125 (b_{K},b_{K′+1} . . . b_{2K′-1}1) each of length K′+1.

In some embodiments, the system 1100 includes a maintained matrix 1130 and uses first token 1120 and second token 1125 to decide a token embedding of the memory command 1105, which is a row vector of length D indexed by the first token 1120 or the second token 1125 and selected from maintained matrix 1130. The system for token embedding is described with reference to FIG. 12. As each bᵢ(i ϵ{0, . . . , 2K′−1}) is a bit, there are 2^{K′} choices for first token 1120 and 2^{K′} choices for second token 1125. Correspondingly, the maintained matrix 1130 has 2×2^{K′}=2^{K′+1} rows and D columns. In some cases, the length D of the row vector refers to the embedding dimension D as described with reference to FIG. 3. In some examples, the first token 1120 corresponds to a row vector of the maintained matrix 1130 indexed by b₀b₁ . . . b_{K′-1}0, and the second token 1125 corresponds to the row vector of the maintained matrix 1130 indexed by b_{K′}b_{K′+1} . . . b_{2K′-1}1.

In some examples, operations by the system 1100 are performed by, or includes aspects of, operations as described with reference to FIGS. 3, 12 and 14. In some embodiments, the maintained matrix 1130 having 2^{K′+1} rows and D columns is referred to as embedding matrix. In some embodiments, the embedding matrix is trained by a procedure as described with reference to FIGS. 3 and 14, for example by passing to the plurality of transformer encoder layers 320 or being trained by the procedure 1400.

FIG. 12 shows an example of a system for token embedding based on a sequence of memory commands according to aspects of the present disclosure. The example shown includes system 1200, a sequence of memory commands 1205, an embedding system 1210, and matrix 1215.

The sequence of memory commands 1205 includes a sequence of memory commands each as described with reference to the memory command 1105 with reference to 11. In some cases, the sequence of memory commands includes aspects of the sequence of memory commands as described with reference to FIG. 3, and a length N of the sequence of memory commands refers to the number N of the plurality of continuous commands as described with reference to FIG. 3.

At the embedding system 1210, each command in the sequence of memory commands 1205 is processed by the system 1100. For each command, system 1100 obtains two row vectors, each of length D, from the maintained matrix 1130 as described with reference to FIG. 11. 2N row vectors obtained from the embedding system 1210 is then collected into an 2N×D matrix, namely, matrix 1215. In some embodiments, the matrix 1215 untrained.

FIG. 13 shows an example of a ransomware information generation system for a sequence of memory commands according to aspects of the present disclosure. The example shown includes system 1300, a sequence of memory commands 1305, a trained model 1310, a first ransomware information 1315, and a second ransomware information 1320.

The sequence of memory commands 1305 is a sequence of memory commands in which ransomware detection will be performed. In some cases, the sequence of memory commands 1305 is an example of, or includes aspects of, the sequence of memory commands as described with reference to FIGS. 1-2 and 10.

The trained model 1310 is a trained machine learned model taking the sequence of memory commands 1305 as input and generates a ransomware information. In some cases, the ransomware information indicates a presence of a ransomware attack on the memory device. In some cases, the trained model 1310 may be an example of, or includes aspects of, the transformer model as described with reference to FIGS. 3-4. In some cases, the trained model 1310 may be trained by the step-by-step procedure for training a machine learning model as described with reference to FIG. 14. In some case, the ransomware information may be the ransomware information as described with reference to FIGS. 1-2. In some cases, the ransomware information may be an example of, or includes aspects of, the output of the transformer model as described with reference to FIGS. 3-4.

The first ransomware information 1315 represents presence or absence of a ransomware attack for each of the memory command in the sequence of memory commands represented by a Boolean value in a corresponding entry of the output. In some cases, the ransomware detection device described with reference to FIG. 1 executes each of the memory command based on the first ransomware information 1315; in one or more examples, executing the memory command based on the first ransomware information 1315 includes refraining from executing the memory command. In one or more examples, based on the first ransomware information 1315, the ransomware detection device described with reference to FIG. 1 further raises alarm over the presence of ransomware, counts the ransomware content in the input, disables the ransomware attacks, or performs any combination thereof. In some cases, the first ransomware information 1315 is an example of, or includes aspects of, the ransomware information as described with reference to FIG. 3.

The second ransomware information 1320 indicates presence of one or more ransomware attacks in the sequence of memory commands. Particularly, the second ransomware information 1320 is a real number between 0 and 1, both ends inclusive, representing a fraction of commands with ransomware attacks present among the sequence of commands. In some cases, the ransomware detection device described with reference to FIG. 1 executes the sequence of memory commands 1305 based on the second ransomware information 1320; in one or more examples, executing the sequence of memory commands 1305 based on the second ransomware information 1320 includes refraining from executing an entirety or part of the sequence of memory commands 1305. In one or more examples, based on the second ransomware information 1320, the ransomware detection device described with reference to FIG. 1 further raises alarm over the presence of ransomware, measures the ransomware content in the input, disables the ransomware attacks, or performs any combination thereof. In some cases, the second ransomware information 1320 is an example of, or includes aspects of, the ransomware information as described with reference to FIG. 3.

### Training

FIG. 14 shows an example of a step-by-step procedure for training a machine learning model according to aspects of the present disclosure. FIG. 14 shows a flow diagram depicting an algorithm as a step-by-step procedure 1400 in an example implementation of operations performable for training a machine-learning model. In some embodiments, the procedure 1400 describes a training operation for the transformer model as described with reference to FIG. 3-4 or 11-12. The procedure 1400 provides one or more examples of generating training data, use of the training data to train a machine learning model, and use of the trained machine learning model to perform a task.

To begin in this example, a machine-learning system collects training data including attributes of memory commands (block 1405) to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

To train the machine-learning model in the illustrated example, the machine-learning model is first initialized (block 1410). In the present disclosure, the model structure is an example of, or includes aspects of, the transformer model as described with reference to FIGS. 3-4, but those skilled may initialize of the machine-learning model by selecting a different model architecture to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

In some cases, when initializing the machine learning model at initialization of the machine learning model (block 1410), a loss function is also selected. The loss function is utilized to measure a difference between an output of the machine-learning model (i.e., predictions) and target values (e.g., as expressed by the training data) to be used to train the machine-learning model. In some cases, additionally, an optimization algorithm is selected to be used in conjunction with the loss function to optimize parameters of the machine-learning model during training, examples of which include gradient descent, stochastic gradient descent (SGD), and so forth. In some cases, initialization of the machine-learning model further includes setting initial values of the machine-learning model examples of which includes initializing weights and biases of nodes to increase efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1415) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, the procedure 1400 includes evaluating the machine learning model on training data (block 1420). In some examples, the training data refers to, is an example of, or includes aspects of, the memory command or the sequence of memory commands as described with reference to FIGS. 1-3 and 8-9. In some cases, the procedure 1400 further includes determining whether a stopping criterion is met, i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met, the procedure 1400 continues training of the machine-learning model using the training data (blocks 1415, 1420) in this example.

After the machine-learning model is sufficiently trained, the trained machine-learning model is then utilized to generate an output based on subsequent data (block 1425). In some cases, when the procedure further includes determining whether the stopping criterion is met, the machine-learning is sufficiently trained if the stopping criterion is met. The trained machine-learning model, for instance, is trained to perform a task as described above and therefore, once trained is configured to perform that task based on subsequent data received as an input and processed by the machine-learning model.

Performance of apparatus, systems and methods of the present disclosure have been evaluated, and results indicate embodiments of the present disclosure have obtained increased performance over conventional technology. Example experiments demonstrate that the ransomware detection apparatus and machine learning model described in embodiments of the present disclosure outperforms conventional systems.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also, the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

1. A method comprising:
obtaining a sequence of memory commands indicating operations of a memory device;
generating, using a transformer model, ransomware information, indicating a presence or an absence of a ransomware attack on the memory device, for each of the memory commands; and
executing one or more of the memory commands in the sequence based on the ransomware information.

2. The method of claim 1, further comprising:
generating one or more tokens representing features of each of the memory commands, wherein the ransomware information is generated based on the one or more tokens.

3. The method of claim 2, wherein:
the one or more tokens comprise a timestamp, a block address, a number of blocks, an opcode, or any combination thereof.

4. The method of claim 2, wherein:
the one or more tokens comprise a file path, a Process ID (PID), or both.

5. The method of claim 1, further comprising:
obtaining a command attribute comprising a Write after read (WAR) attribute, a Write after write (WAW) attribute, a Read after read (RAR) attribute, a Read after write (RAW) attribute, or any combination thereof, wherein the ransomware information is generated based on the command attribute.

6. The method of claim 1, further comprising:
triggering an alarm based on the ransomware information.

7. The method of claim 1, further comprising:
disabling the ransomware attack based on the ransomware information.

8. The method of claim 1,
wherein the ransomware information includes a command-specific ransomware indicator for each of the sequence of memory commands, respectively.

9. The method of claim 1, wherein generating the ransomware information comprises:
obtaining a position encoding for each of the memory commands; and
performing a self-attention operation of each of the memory commands based on the position encoding.

10. The method of claim 1, wherein:
the transformer model is trained using training data including a sequence of memory commands.

11. A non-transitory computer readable medium storing code for ransomware detection, the code comprising instructions that, when executed by at least one processor, cause the at least one processor to perform operations comprising:
obtaining a sequence of memory commands indicating operations of a memory device;
generating, using a transformer model, ransomware information, indicating a presence or an absence of a ransomware attack on the memory device, for each of the memory commands; and
executing one or more of the memory commands in the sequence based on the ransomware information.

12. The non-transitory computer readable medium of claim 11, wherein the operations performed by the at least one processor further comprise:
generating one or more tokens representing features of each of the memory commands, wherein the ransomware information is generated based on the one or more tokens.

13. The non-transitory computer readable medium of claim 12, wherein:
the one or more tokens comprise a file path, a Process ID (PID), or both.

14. The non-transitory computer readable medium of claim 11, wherein the operations performed by the at least one processor further comprise:
obtaining a command attribute comprising a Write after read (WAR) attribute, a Write after write (WAW) attribute, a Read after read (RAR) attribute, a Read after write (RAW) attribute, or any combination thereof, wherein the ransomware information is generated based on the command attribute.

15. The non-transitory computer readable medium of claim 11,
wherein the ransomware information includes a command-specific ransomware indicator for each of the sequence of memory commands, respectively.

16. An electronic device comprising:
a memory device; and
a processing device coupled to the memory device, the processing device configured to perform operations comprising:
obtaining a sequence of memory commands indicating operations of the memory device;
generating, using a transformer model, ransomware information, indicating a presence or an absence of a ransomware attack on the memory device, for each of the memory commands; and
executing one or more of the memory commands in the sequence based on the ransomware information.

17. The electronic device of claim 16, wherein:
the memory device comprises a non-volatile memory.

18. The electronic device of claim 16, wherein:
the memory device comprises a solid state device.

19. The electronic device of claim 16, wherein the operations performed by the processing device further comprise:
generating one or more tokens representing features of each of the memory commands, wherein the ransomware information is generated based on the one or more tokens.

20. The electronic device of claim 16, wherein generating the ransomware information comprises:
obtaining a position encoding for each of the memory commands; and
performing a self-attention operation of each of the memory commands based on the position encoding.
